(19) United States
(12) Patent Application Publication
(10) Pub. No.: US 2025/0176032 A1
(43) Pub. Date: May 29, 2025

(54) RANDOM ACCESS RESPONSE FOR CODEWORD-BASED RANDOM ACCESS CHANNEL COMMUNICATIONS

(71) Applicant: QUALCOMM Incorporated, San Diego, CA (US)

(72) Inventors: Ayan SENGUPTA, San Diego, CA (US); Alberto RICO ALVARINO, San Diego, CA (US); Umesh PHUYAL, San Diego, CA (US); Bharat SHRESTHA, San Diego, CA (US); Xiao Feng WANG, San Diego, CA (US); Le LIU, San Jose, CA (US); Syed Hashim Ali SHAH, San Diego, CA (US)

(21) Appl. No.: 18/899,724

(22) Filed: Sep. 27, 2024

Related U.S. Application Data
(60) Provisional application No. 63/603,984, filed on Nov. 29, 2023.

(51) Int. Cl. H04W 74/0833; H04W 74/00

(52) U.S. Cl. CPC H04W 74/0833; H04W 74/006

(57) ABSTRACT

Certain aspects of the present disclosure provide techniques for communicating a random access response (RAR) for codeword-based random access channel (RACH) communications. An example method for wireless communications by an apparatus includes sending a first signal in one or more first time-frequency resources associated with a RACH, wherein the first signal is multiplexed using a first codeword, the one or more first time-frequency resources and the first codeword defining a first preamble signature; receiving a RAR indicating the first codeword; and communicating with a network entity in response to receiving the RAR.

### CROSS-REFERENCE TO RELATED APPLICATION(S)

The present application for patent claims benefit of U.S. Provisional Application No. 63/603,984, filed Nov. 29, 2023, which is hereby expressly incorporated by reference herein in its entirety.

### INTRODUCTION

### Field of the Disclosure

Aspects of the present disclosure relate to wireless communications, and more particularly, to techniques for random access communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus (e.g., a user equipment). The method includes sending a first signal in one or more first time-frequency resources associated with a random access channel (RACH), wherein the first signal is multiplexed using a first codeword, the one or more first time-frequency resources and the first codeword defining a first preamble signature; receiving a random access response (RAR) indicating the first codeword; and communicating with a network entity in response to receiving the RAR.

Another aspect provides a method for wireless communications by an apparatus (e.g., a network entity). The method includes obtaining a first signal in one or more first time-frequency resources associated with a RACH, wherein the first signal is multiplexed using a first codeword, the one or more first time-frequency resources and the first codeword defining a first preamble signature; sending a RAR indicating the first codeword; and communicating with a user equipment in response to sending the RAR.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A is an example process flow diagram illustrating an example four-step RACH procedure performed between a UE and a network entity.

FIG. 5B is an example process flow diagram illustrating an example two-step RACH procedure performed between a UE and a network entity.

FIG. 6 is a diagram illustrating an example narrowband physical random access channel resource grid using code division multiplexing for a random access preamble transmission.

FIG. 7 is a diagram illustrating an example medium access control protocol data unit for communicating one or more random access responses (RARs) to one or more UEs.

FIG. 8A is a diagram illustrating an example random access preamble identifier (RAPID) subheader.

FIG. 8B is a diagram illustrating an example RAR payload.

FIG. 8C is a diagram illustrating an example backoff subheader.

FIG. 9 depicts a process flow for communications in a network between a UE and a network entity.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for communicating a random access response (RAR) for codeword-based random access channel (RACH) communications.

Certain wireless communications (e.g., Narrowband Internet of Things (NB-IoT) communications for Evolved Universal Terrestrial Radio Access (E-UTRA) systems and/or 5G New Radio (NR) systems) may use a specified set of resources for random access to the radio access network (RAN). For example, NB-IoT devices may be allocated a certain number of subcarriers in a narrowband physical random access channel (NPRACH) to randomly select for random access to the RAN. In certain aspects, where the RAN is discussed herein as performing one or more operations, such operation(s) may be performed by one or more network entities (e.g., a base station and/or a disaggregated entity thereof) of the RAN.

Technical problems for narrowband communications may include, for example, providing sufficient capacity for random access communications. As the number of deployed NB-IoT devices increases in the coverage area of a RAN (e.g., with the increased adoption of IoT devices in communication with a wireless wide area network (WWAN)), there may be an increased likelihood of NB-IoT devices using the same subcarrier for random access. In such cases, where multiple NB-IoT devices are transmitting via the same subcarrier for random access, the RAN may be unable to decode certain random access transmissions (e.g., a RACH preamble or a MSG3 transmission) from the NB-IoT devices and respond to such transmissions. As such, an NB-IoT device may perform multiple RACH attempts to establish a communication link with the RAN. Accordingly, the RACH attempts may use a non-trivial amount of time and contribute to the latency encountered by the NB-IoT to establish the communication link.

Certain aspects of the present disclosure may overcome the aforementioned technical problem(s), for example, by providing an architecture for a RAR that facilitates codeword-based RACH communications. Codeword-based RACH communications may use code division multiplexing to increase the resources available for RACH communications. In certain aspects, the RAN may send a bundled RAR transmission having multiple RARs associated with multiple preambles to facilitate an efficient random access procedure that communicates with multiple user equipment. As multiple preambles for codeword-based RACH communications may be transmitted via the same subcarrier (which may be used to identify the association between a RAR and a preamble), the RAR for a given codeword-based preamble may be identified in part by the codeword used for sending such a preamble as further described herein. In certain aspects, the bundled RAR transmission may be compatible for multiple types of preambles, for example, RAR(s) associated with codeword-based preamble(s) and non-codeword-based preamble(s). For certain aspects, the bundled RAR transmission may be specific to codeword-based preambles without any RARs associated with non-codeword-based preamble(s). For certain aspects, a RAR may indicate a backoff parameter value that is specific to codeword-based RACH communications. Such a backoff indication may allow the RAN to indicate backoff instructions for codeword-based RACH communications separate from non-codeword-based RACH communications.

The techniques for communication of the RAR described herein may provide various technical effects and/or advantages. For example, the RAR communications described herein may improve wireless communication performance including, for example, an increased throughput, decreased latency, and/or increased random access channel capacity. The improved performance may be attributable to codeword-based RACH communications, which may be facilitated by the RAR communications as further described herein. For example, the codeword-based RACH communications may enable increased capacity for RACH communications; and the increased capacity may enable reduced latencies, for example, due to a network entity being able to successfully decode preamble transmissions and respond accordingly.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

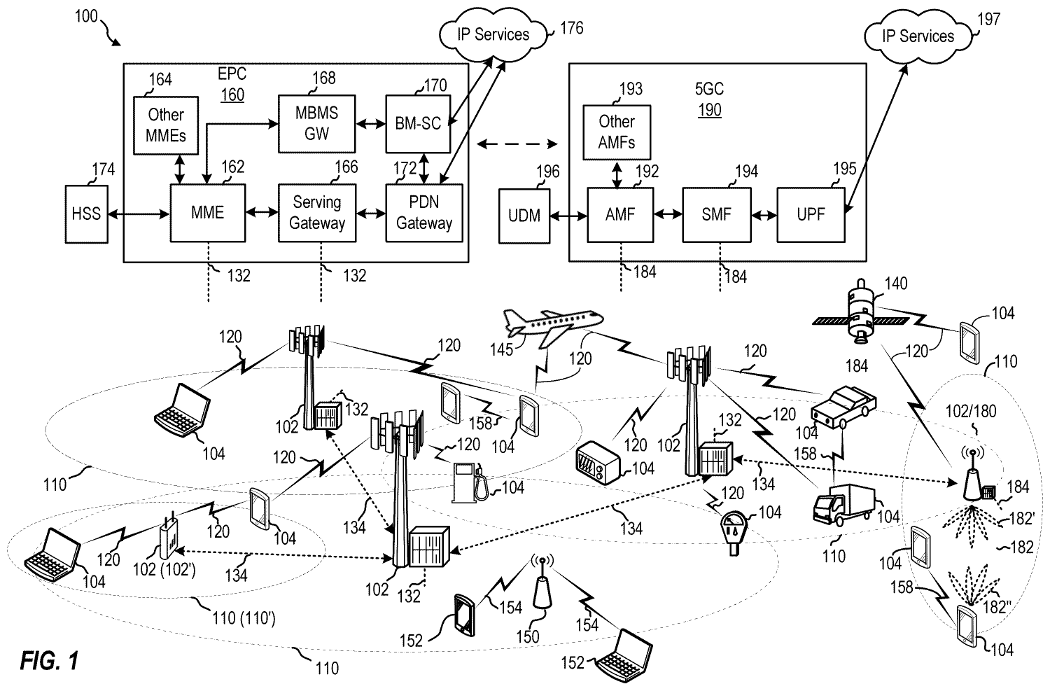

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

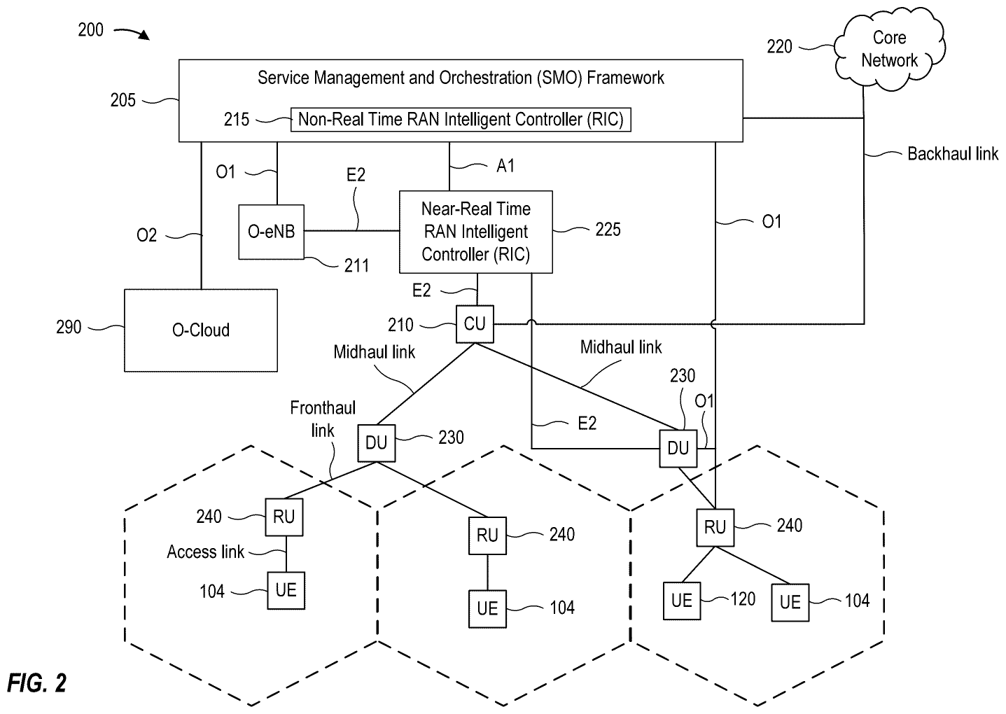

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

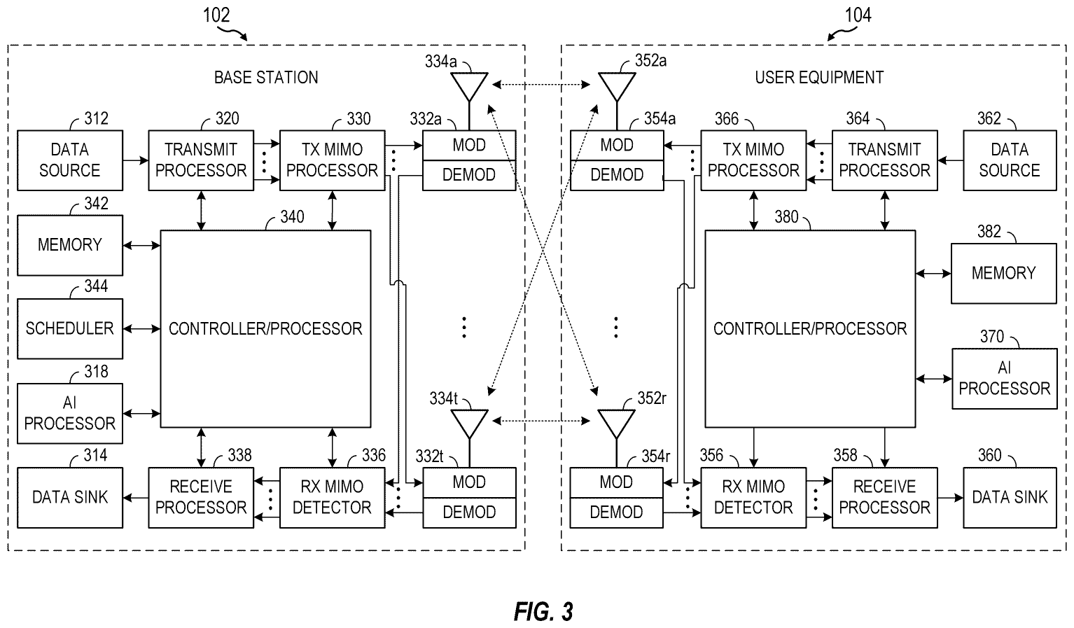

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

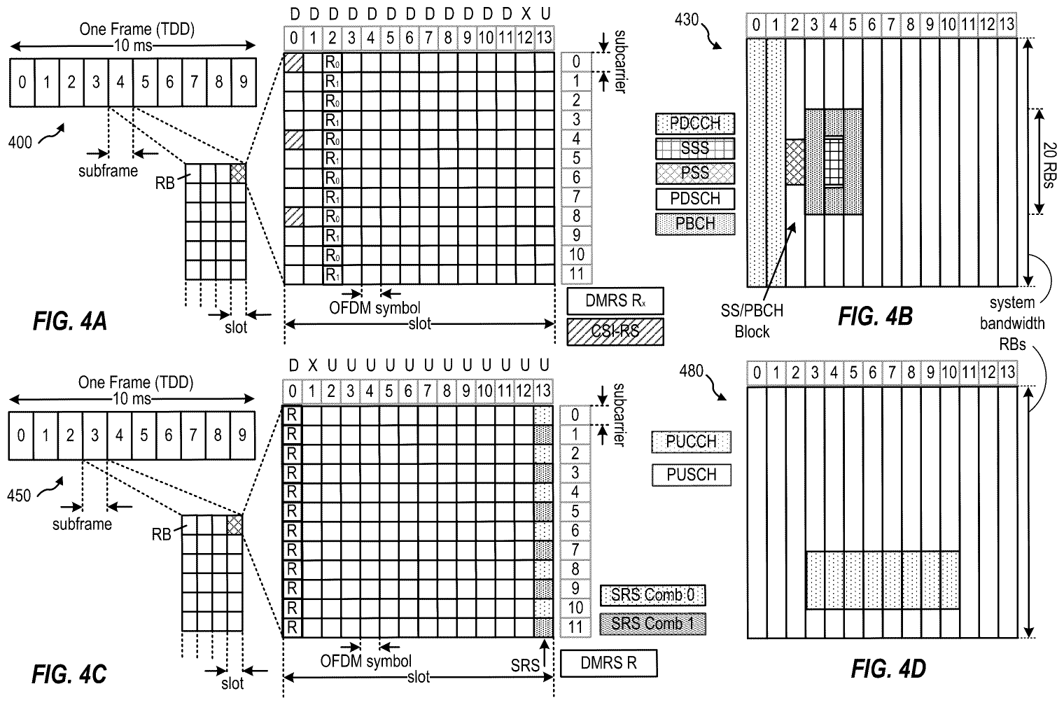

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., an E-UTRA system and/or 5G NR system) may provide a specified channel for random access, such as a random access channel (RACH), and corresponding random access procedures. A UE may use the RACH for initial access to a RAN, for example. A random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

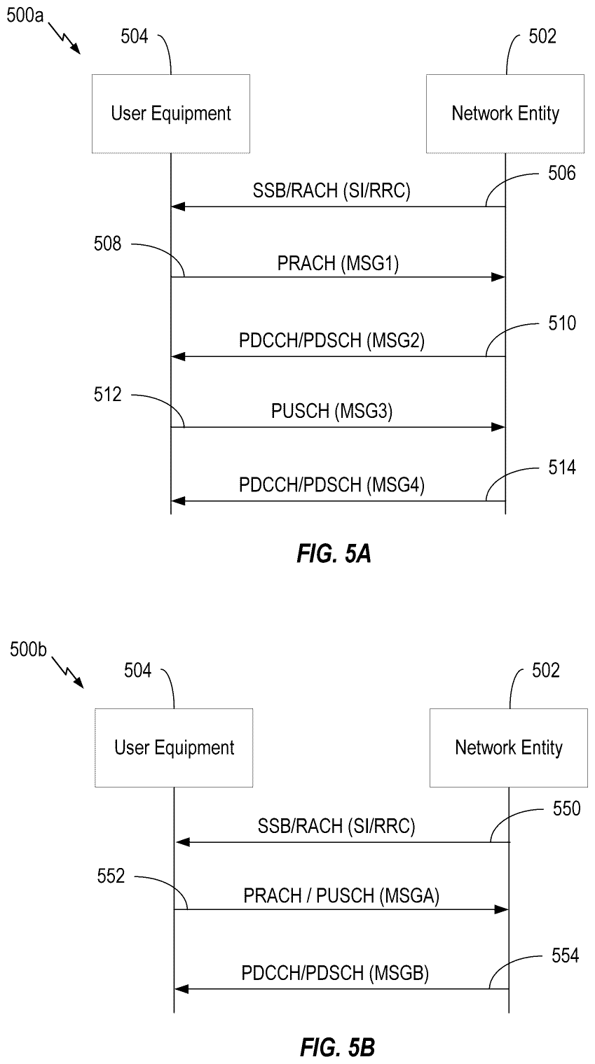

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may optionally begin at 506, where the network entity 502 broadcasts and the UE 504 receives a random access configuration, for example, in system information within a synchronization signal block, or within an RRC message. The random access configuration may indicate or include one or more parameters for random access communications, such as defining the RACH, the number of random access preambles (e.g., preamble sequences) available for random access, power ramping parameters, response window size, etc.

At 508, the UE 504 sends a first message (MSG1) to the network entity 502 on a physical random access channel (PRACH). In some aspects, MSG1 may indicate or include a RACH preamble. The RACH preamble may indicate or include a preamble signature associated with the RACH preamble. The preamble signature may correspond to a particular preamble sequence (e.g., a Zaddoff Chu sequence) generated across time-frequency resources used for the preamble transmission. For contention-based random access, the preamble sequence may be randomly selected among a set of preamble sequences (e.g., up to 64 sequences in some cases). The preamble signature may be used to identify the UE for scheduling communications (e.g., MSG2 and MSG3) with the network entity. The term “RACH preamble” may refer to or correspond to “random access preamble,” “preamble,” and/or “preamble signature.”

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and a backoff parameter value. The RAPID may correspond to the preamble signature and indicate that the RAR is for the UE 504 that transmitted MSG1 at 506. As an example, the RAPID may identify a particular frequency resource used for the preamble transmission. As further described herein, the backoff parameter value may be used to determine a RACH occasion for sending a subsequent RACH transmission (e.g., a preamble transmission). A RACH occasion may correspond to one or more time resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 may use the time-frequency resource(s) indicated in the UL grant of the RAR.

At 514, the network entity 502 may send a contention resolution message (MSG4) in response to MSG3. The network entity 502 may send a downlink scheduling command (e.g., DCI), which is addressed to a specific UE identity associated with the UE 504 as discussed below, via the PDCCH. The network entity 502 may send a UE contention resolution identity (e.g., a medium access control element) via the PDSCH according to the downlink scheduling command. In certain cases, multiple UEs may send the same preamble in the same random access occasion. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity 502 was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to receive or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the RACH, and the payload of MSGA may be transmitted over the PUSCH, for example.

At 554, the network entity 502 may send a random access response message (MSGB), which may effectively combine MSG2 and MSG4 described above. For example, MSGB may include a RAPID, a timing advance, a backoff parameter value, a contention resolution message, an uplink and/or downlink grant, and transmit power control commands.

### Example NB-IoT Communications

Certain wireless communication systems (e.g., an E-UTRA system and/or 5G NR system) may enable access to network services using a physical layer configured for very low power consumption and low complexity, which may be beneficial for Internet-of-Things (IoT) devices operating on battery power or power harvesting circuitry. These low power network services may be referred to as narrowband IoT (NB-IoT) communications. For NB-IoT communications, a UE may be capable of data rates up to 68 kbps for downlink and up to 132 kbps for uplink, for example, via a full carrier bandwidth of 180-200 kHz and a subcarrier spacing of 3.75 kHz or 15 kHz. At such a low bandwidth, the NB-IoT device may support a low complexity transceiver to enable a low cost solution for IoT devices. In certain cases, a UE may be equipped with only a single antenna to facilitate the low power consumption. The low power consumption may enable an NB-IoT device to operate for at least 10 years on battery power or almost indefinitely with power harvesting. Those of skill in the art will understand that the specification associated NB-IoT communications (e.g., the data rates, carrier bandwidth, and/or subcarrier spacing) are merely examples. Other specifications may be used in addition to or instead of those described.

NB-IoT communications may use a specified set of resources (e.g., RACH subcarriers) for random access to the RAN. For example, NB-IoT devices may be allocated up to 48 subcarriers in a NPRACH to select for random access to the RAN. As the number of deployed NB-IoT devices increases in a RAN (e.g., with the increased adoption of wirelessly connected IoT devices), there may be an increased likelihood of NB-IoT devices using the same subcarrier for random access. In such cases, where multiple NB-IoT devices are transmitting via the same subcarrier for random access, the RAN may be unable to decode certain random access transmissions (e.g., a MSG1 transmission or a MSG3 transmission) from the NB-IoT devices and respond to such transmissions, for example, due to inference between the overlapping transmissions from multiple NB-IoT devices. As such, NB-IoT devices may send an increased number of RACH attempts to establish a communication link with the RAN, which may result in an increased latency to establish a communication link with the RAN. As the random access procedure is used for various of events, the performance of the random access procedure affects the performance of a variety of wireless communication activities, such as initial access, handover, UL/DL data arrival, etc.

### Aspects Related to RAR for Codeword-Based RACH Communications

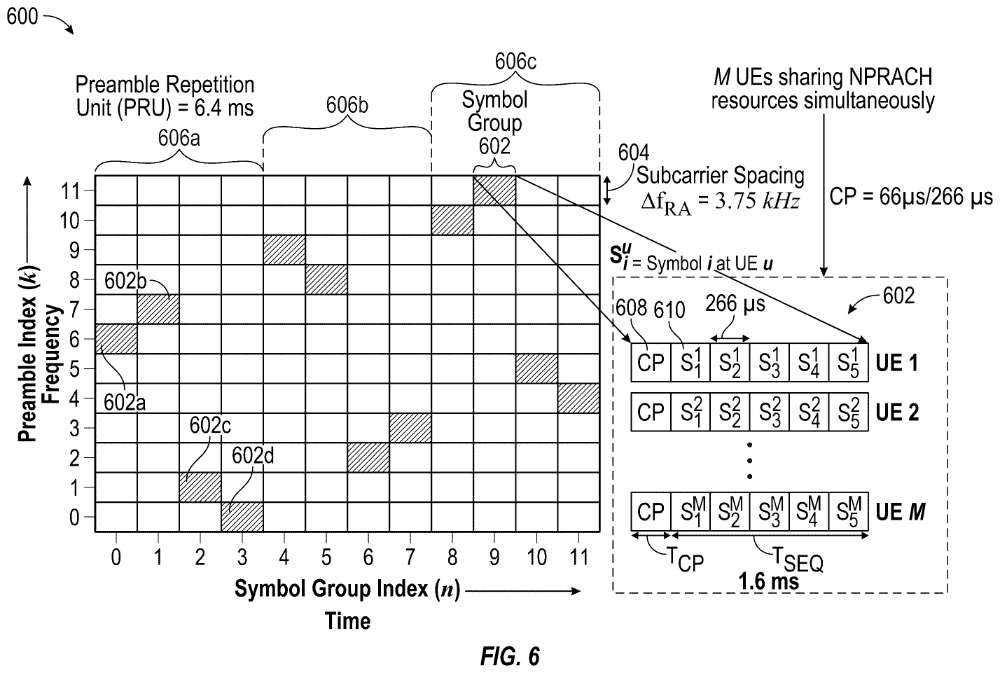

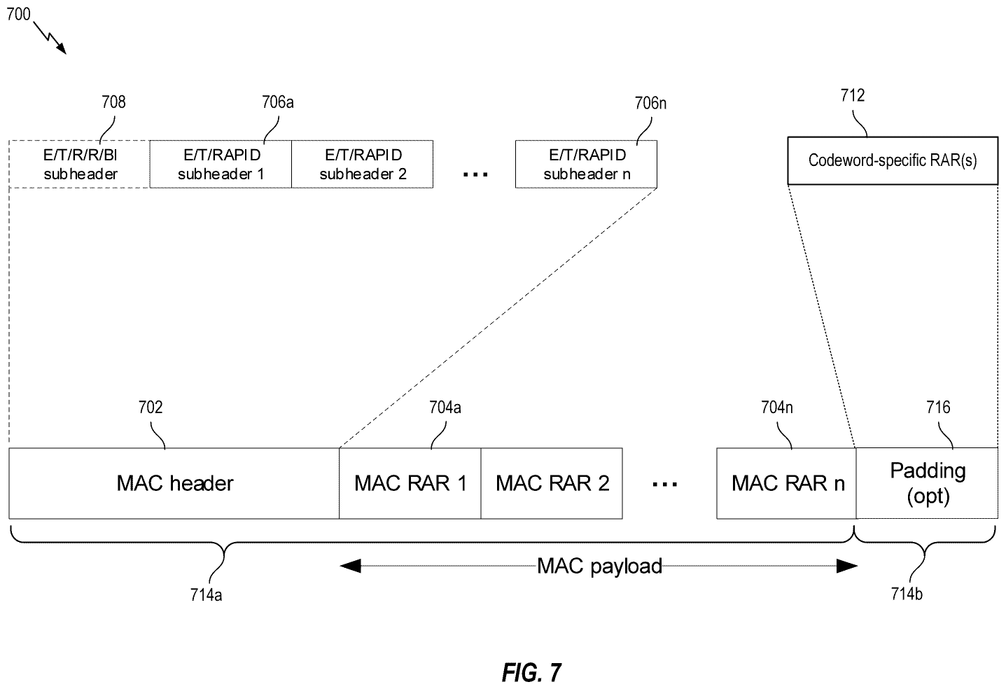

Aspects of the present disclosure provide an architecture for a RAR that facilitates codeword-based RACH communications. Codeword-based RACH communications may use code division multiplexing (e.g., an orthogonal cover code (OCC)) to increase the resources available for RA and/or RACH communications, for example, as further described herein with respect to FIG. 6. Codeword-based RACH communications may include codeword-based RACH communications (e.g., MSG1) and/or codeword-based random access communications (e.g., MSG2, MSG3, and/or MSG4). In certain aspects, the RAN (e.g., a network entity of the RAN) may send a bundled RAR transmission having multiple RARs associated with multiple preambles to facilitate an efficient random access procedure (for example, as further described herein with respect to FIG. 7) with multiple UEs (e.g., NB-IoT devices). As multiple preambles for codeword-based RACH communications may be transmitted via the same subcarrier (which may be used to identify the association between a RAR and a preamble transmission), the RAR for a given codeword-based preamble may be identified in part by the codeword used for sending such a preamble as further described herein.

In certain aspects, the bundled RAR transmission may be compatible for multiple types of preambles, for example, RAR(s) associated with codeword-based preamble(s) and non-codeword-based preamble(s). For example, the bundled RAR transmission may be segmented into a first portion conveying (e.g., indicating or including) RAR(s) associated with codeword-based preambles and a second portion conveying RAR(s) associated with non-codeword-based preambles.

For certain aspects, the bundled RAR transmission may be specific to codeword-based preambles, in some cases, without any RARs associated with non-codeword-based preamble(s). For example, the RAN may send scheduling for the bundled RAR transmission using a codeword-specific random access radio network temporary identifier (RA-RNTI), as further described herein.

In certain aspects, a RAR may indicate a backoff parameter value that is specific to codeword-based RACH communications. Such an indication of the backoff may allow the RAN to indicate backoff instructions for codeword-based RACH communications separate from non-codeword-based RACH communications, for example, depending on the channel load associated with codeword-based RACH communications.

The techniques for communicating the RAR described herein may provide various technical effects and/or advantages. For example, the RAR communications described herein may improve wireless communication performance including, for example, an increased throughput, decreased latency, increased number of devices (e.g., NB-IoT devices) that can access a RACH, increased resources available for random access, etc. In some aspects, the improved performance may be attributable to codeword-based RACH communications increasing the RACH resources available for random access (e.g., increased channel capacity), which may be facilitated by the RAR communications described herein. As an example, the RAR communications described herein may allow a RAN to indicate the association between a given RAR and codeword-based preamble, and thus, the RAR may allow the RAN to respond to codeword-based RARs efficiently (e.g., alongside other types of preambles and/or via a codeword-specific RAR). In some cases, the backoff parameter value described herein may allow a RAN to tailor backoff instructions for subsequent RACH transmissions to codeword-based RACH communications without affecting non-codeword-based RACH communications.

FIG. 6 is a diagram illustrating an example NPRACH resource grid 600 using code division multiplexing for a random access preamble transmission (e.g., MSG1). In this example, the NPRACH resource grid 600 may include a set of one or more symbol groups 602 arranged across a set of one or more subcarriers 604, which may have a subcarrier spacing of 3.75 kHz (or 15 kHz), for example. As shown, the symbol groups 602 may correspond to symbol group indices (n), and the subcarriers 604 may correspond to preamble indices (k) in the NPRACH resource grid 600. In some cases, the subcarriers 604 may include a contiguous set of subcarriers and a contiguous set of symbol groups. The NPRACH resource grid 600 may correspond to one or more NPRACH resources. In some cases, the NPRACH resource grid 600 may include a certain number of subcarriers, e.g., up to 48 subcarriers.

A random access preamble (e.g., MSG1) may include or be formed in a sequence of symbol groups 602 (e.g., symbol groups 602a-d). In some cases, the random access preamble may be transmitted with repetition, for example, to enhance the reliability of the preamble transmission and/or enhance the coverage area (e.g., transmission range). As an example, a random access preamble may include one or more preamble repetition units (PRUs) 606a-c, and a PRU (e.g., the first PRU 606a) may include a sequence of one or more symbol groups 602 (e.g., the symbol groups 602a-d in the first PRU 606a). Each PRU may correspond to an instance (also referred to as repetition) of the random access preamble. The random access preamble having P symbol groups may be transmitted Nᵣₑₚ^{NPRACH} times.

A symbol group 602 may include a cyclic prefix (CP) 608 of length τ_{CP} (e.g., 66 μs or 266 μs) and a sequence of N symbols 610 with total length τ_{SEQ} (e.g., symbol duration=266 μs). With code division multiplexing (e.g., applying M orthogonal cover codes (OCCs) to a symbol group), M codeword-based symbol groups (e.g., M-codeword-based signals having a length of the symbol group) may be able to share the same time-frequency resource (e.g., the same subcarrier in the same symbol group index). For example, a particular codeword may be used to form a baseband signal of a preamble transmission associated with the symbol group 602. Accordingly, the time-frequency resources and the codeword may be used to define or form a preamble signature associated with the preamble transmission, and the preamble signature may be used to identify the preamble transmission of a UE. The codeword-based symbol groups may allow multiple UEs to transmit on the same NPRACH resources, and thus, the number of UEs that can perform random access at the same time without collision on the NPRACH resources for random access may be proportionally increased by the number of codewords used for code division multiplexing. Such an increase in for the number of UEs that can perform random access without collision may alleviate channel congestion as more NB-IoT devices are deployed in the network.

In some cases, the random access preamble may include a sequence of subcarrier frequency-hopping symbol groups 602. As an example, the first PRU 606a may include a first symbol group 602a, a second symbol group 602b, a third symbol group 602c, and a fourth symbol group 602d arranged in symbol group indices 0-3, respectively. According to an example frequency hopping pattern, the first symbol group 602a is arranged in the subcarrier corresponding to preamble index 6; the second symbol group 602b is arranged in the subcarrier corresponding to preamble index 7; the third symbol group 602c is arranged in the subcarrier corresponding to preamble index 1; and the fourth symbol group 602d arranged in the subcarrier corresponding to preamble index 0. Likewise, the symbol groups associated with the second PRU 606b and the third PRU 606c may be arranged in the subcarriers of the NPRACH resource grid 600 according to the frequency hopping pattern.

In certain aspects, each of the PRUs 606a-c may be arranged in different subcarriers per the frequency hopping pattern. In some cases, the frequency hopping pattern may be defined relative to the start subcarrier for the preamble transmission, as in the start subcarrier of the first PRU in time of the preamble transmission. For example, if multiple UEs select the same start subcarrier for the preamble transmission (e.g., preamble index 6), the frequency hopping pattern may result in overlapping preamble transmissions that use the same frequency resources.

An example NPRACH configuration (e.g., provided by RRC signaling and/or system information) may include an NPRACH resource periodicity N_{period}^{NPRACH} (nprach-Periodicity)—for example, the periodicity for the NPRACH, a frequency location of the first subcarrier allocated to NPRACH N_{scoffset}^{NPRACH} (nprach-SubcarrierOffset), a number of subcarriers allocated to NPRACH N_{sc}^{NPRACH} (nprach-NumSubcarriers), a number of starting subcarriers allocated to UE initiated random access N_{sc_cohl}^{NPRACH} (nprach-NumCBRA-StartSubcarriers)—for example, the number of subcarriers allocated for CBRA, a number of NPRACH repetitions per attempt Nᵣₑₚ^{NPRACH} (numRepetitionsPerPreambleAttempt), NPRACH starting time Nₛₜₐᵣₜ^{NPRACH} (nprach-StartTime), and/or a fraction for calculating starting subcarrier index for the range of NPRACH subcarriers reserved for indication of UE support for multi-tone MSG3 transmission N_{MSG3}^{NPRACH} (nprach-SubcarrierMSG3-RangeStart).

In certain aspects, the RAN may send a RAR transmission as a data block (e.g., one or more transport blocks), which may include a MAC protocol data unit (PDU), in time-frequency resource(s) (e.g., PDSCH). The MAC PDU may carry one or more RARs, where each of the RARs may be associated with a given preamble transmission as further described herein.

FIG. 7 is a diagram illustrating an example MAC PDU 700 for communicating (e.g., broadcasting or multicasting) one or more RARs to one or more UEs. In this example, the MAC PDU 700 may include a MAC header 702 and one or more RAR payloads 704a-n. The MAC header 702 may include one or more RAPID subheaders 706a-n, and in some cases, a backoff subheader 708. In certain aspects, the MAC PDU 700 may include one or more codeword-specific RAR(s) 712, as further described herein. The RAR payloads 704a-n may be part of a MAC payload, which may also include padding bit(s) and/or the codeword-specific RAR(s) 712 (as further described herein).

Each of the RAPID subheaders 706a-n may correspond to at least one of the RAR payloads 704a-n, for example, according to the order in which the RAPID subheaders 706a-n and the RAR payloads 704a-n are arranged in the MAC PDU 700. As an example, the first RAPID subheader 706a in the sequence of RAPID subheaders 706a-n corresponds to the first RAR payload 704a in the sequence of RAR payloads 704a-n, and so on to the last (nth) RAPID subheader 706n corresponding to the last (nth) RAR payload 704n. In certain aspects, a RAPID subheader and corresponding RAR payload may form a RAR associated with a preamble transmission, where each of the RAR payloads 704a-n may be considered a component of the RAR (e.g., a component RAR). The RAPID subheader and corresponding RAR payload may be components of a specific RAR addressed to one or more UEs.

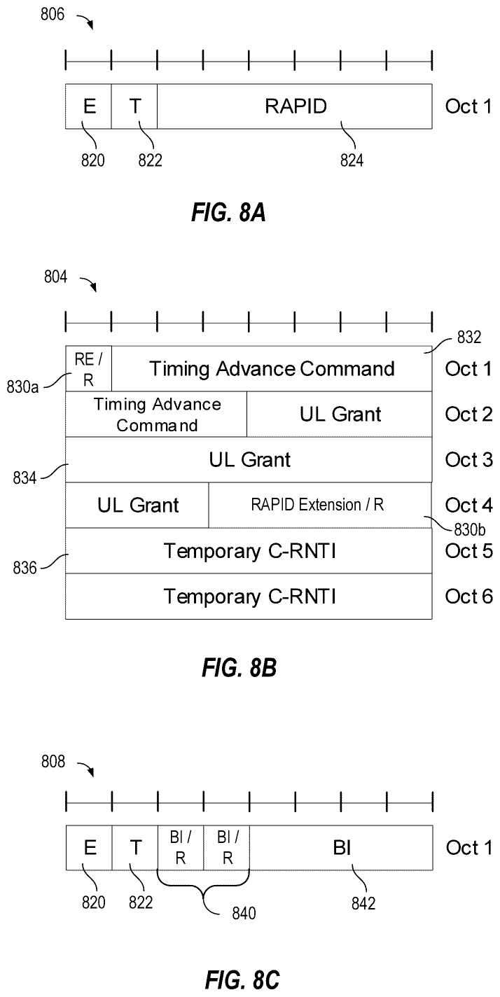

The association between a RAR and a preamble may be indicated via at least the RAPID, for example, in a RAPID subheader as further described herein with respect to FIG. 8A. For NB-IoT devices, the RAPID may correspond to at least a start subcarrier index associated with the preamble. The start subcarrier index may correspond to the subcarrier used to transmit the symbol group beginning a random access preamble transmission (e.g., the earliest symbol group in a sequence of symbol groups associated with a preamble transmission). For example, as depicted in FIG. 6, the preamble may be transmitted starting with the first symbol group 602a in a start subcarrier index 6, which may correspond to the RAPID.

In certain aspects, the MAC PDU 700 carrying the RAR(s) may be multi-compatible for different types of preambles, for example, codeword-based preamble(s) and non-codeword-based preamble(s). In some cases, the RAPID may correspond to a start subcarrier index and a codeword associated with a preamble transmission. For example, a first set of values (e.g., values 0 through 15) of the RAPID may correspond to non-codeword-based preambles (e.g., corresponding to a start subcarrier index), and a second set of values (e.g., values 16 through 63) may correspond to codeword-based preambles (e.g., corresponding to a start subcarrier index and a codeword).

For certain aspects, the MAC PDU 700 may be multi-compatible via data segmentation of the MAC PDU 700. For example, the MAC PDU 700 may include a first data portion 714a and a second data portion 714b. The first data portion 714a may include one or more first RARs (e.g., the RAPID subheaders 706a-n and the RAR payloads 704a-n) associated with non-codeword-based RACH communications, and the second data portion 714b may include one or more second RARs (e.g., the one or more codeword-specific RARs 712) associated with codeword-based RACH communications. In certain aspects, the one or more codeword-specific RARs 712 may be structured according to the first RARs, for example, having RAPID subheader(s) and RAR payload(s). For the codeword-specific RARs 712, the RAPID subheader may have a RAPID value that corresponds to (e.g., maps to) the subcarrier index and the codeword used for the preamble transmission. In some cases, the one or more second RARs may include RARs that are associated with different types of preambles, such as codeword-based preambles and one or more other types of preambles (e.g., preambles for future RACH feature enhancements).

In certain aspects, the second data portion 714b may correspond to (or treated as) one or more padding bits 716 in the MAC PDU 700 by certain UE(s). For example, the UE(s) that do not support codeword-based RACH communications may ignore or refrain from decoding the padding bits 716. The presence and length of the padding bits 716 may be based on the transport block size of the transport block carrying the MAC PDU 700. For example, the transport block size may be selected to accommodate the RAPID subheaders 706a-n and the RAR payloads 704a-n in the first data portion 714a and/or the one or more codeword-specific RARs 712 in the second data portion 714b.

In certain aspects, the association between a RAR and a preamble transmission may be indicated via the RAR subheader and/or certain information in the corresponding RAR payload. For example, the RAR payload may include certain bits that may be used in combination with the RAPID to indicate a codeword-based preamble transmission as further described below.

FIGS. 8A and 8B are diagrams illustrating an example RAPID subheader 806 and an example RAR payload 804, respectively. In these examples, the various fields may be arranged in one or more octets of bits (e.g., a byte). Referring to FIG. 8A, the RAPID subheader 806 may include an extension field (E) 820, a type field (T) 822, and a RAPID field 824, for example, arranged in an octet (October 1).

The extension field 820 may be or include a flag (e.g., a bit flag) indicating if a subsequent RAPID subheader is present in the MAC PDU header. As an example, the extension field 820 may be set to “1” to indicate at least another RAPID subheader (e.g., a set of E/T/RAPID fields) follows. The extension field 820 may be set to “0” to indicate that a RAR payload (e.g., a MAC RAR), one or more padding bits, or a codeword-specific RAR starts at the next byte.

The type field 822 may be or include a flag indicating whether the subheader includes a RAPID or a Backoff Indicator. As an example, the type field 822 may be set to “0” to indicate the presence of a Backoff Indicator field in a backoff subheader, for example, as further described herein with respect to FIG. 8C. The type field 822 may be set to “1” to indicate the presence of the RAPID field in the subheader 806.

The RAPID field 824 may be used to identify a transmitted random access preamble. As an example, the size of the RAPID field 824 may be 6 bits, which may correspond to 64 values for the RAPID.

As shown in FIG. 8B, the RAR payload 804 may include one or more rapid extension fields 830a-b (collectively 830), a time timing advance command field 832, an UL grant field 834, and a temporary cell-RNTI (C-RNTI) field 836, for example, arranged in six octets (October 1-6). In some cases, the structure of the RAR payload 804 as depicted in FIG. 8B may be specified for NB-IoT communications.

The one or more RAPID extension fields 830 may be used to expand the bit space for identifying the RAPID associated with the RAPID subheader 806. For example, a combination of the RAPID field 824 and the one or more RAPID extension fields 830 may identify a specific codeword-based preamble transmission (e.g., the start subcarrier index and the codeword used for the corresponding symbol group of the preamble transmission). The one or more RAPID extension fields 830 may include one or more bits (e.g., 1-6 bits) arranged across or in one or more octets of the RAR payload 804.

As an example, a codeword-capable UE may determine the RAPID for a codeword-based preamble via an expanded RAPID space comprising the RAPID field 824 in the RAPID subheader 806 and the one or more RAPID extension fields 830 (e.g., 1-5 bits) in the corresponding RAR payload 804. In certain cases, for example, where non-codeword-based RACH communications for NB-IoT UEs may use up to 48 values for the RAPID (e.g., 0 to 47), the remaining RAPID values (48 to 63) may be used in combination with the one or more RAPID extension fields 830 for identifying a codeword-based preamble. As an example, assuming the second RAPID extension field 830b (e.g., having a size of 5 bits) is used, the expanded RAPID space may correspond to 512 values for identifying a codeword-based preamble (e.g., 2⁵×(63−47)=32×16=512 RAPID values).

In certain aspects, the one or more RAPID extension fields 830 may correspond to one or more reserved bits for non-codeword-based preambles. For example, a UE that does not support codeword-based RACH communications may ignore or refrain from interpreting the one or more RAPID extension fields 830. Thus, such an architecture for the RAR as described herein allows compatibility with (or support for responding to) multiple types of random access preambles (e.g., codeword-based preambles and non-codeword-based preambles).

The timing advance command field 832 may indicate the index value T_{A} (0, 1, 2 . . . 1282) used to control the amount of timing adjustment that the UE applies for uplink communications with the network entity. For NB-IoT UEs using a specific preamble format (e.g., preamble format 2), the timing advance command field 832 may indicate the index value T_{A} (0, 1, 2 . . . 1536). The size of the timing advance command field 832 may be 11 bits, for example.

The UL grant field 834 may indicate the resources to be used on the uplink for MSG3. For NB-IoT UEs, the size of UL grant field 834 may be 15 bits, and for other types of UEs, the size of UL grant field 834 may be 20 bits or 12 bits, for example.

The Temporary C-RNTI field 834 may indicate the temporary identity that is used by the UE during Random Access, for example, for contention resolution of MSG4. The size of the Temporary C-RNTI field 834 may be 16 bits, for example.

In certain aspects, the RAR may indicate a backoff parameter value that is specific to codeword-based RACH communications. The backoff parameter value in the RAR corresponding to the OCC-supporting UEs may be distinct from (or separate from) another backoff parameter value assigned to other types of UEs, for example. The backoff parameter value may be used to control congestion/load for random access communication, for example, depending on the densities (or occurrence of random access attempts) associated with the type of UE (e.g., OCC-supporting UEs versus other types of UEs). In some cases, the RAN may determine to treat codeword-based RACH communications differently or separately from other RACH communications in terms of the backoff parameter value, for example, due to different overload conditions between codeword-based RACH communications and other RACH communications. The RAN may adjust the backoff parameter value in response to the overload condition of the cell or RACH being accessed by UEs. For example, when the RACH is overloaded (e.g., when the RAN is receiving multiple identical preambles), the RAN may increase the backoff parameter value to delay subsequent RACH transmission from some UEs. When the RACH is underloaded (e.g., when the RAN is receiving very few identical preambles), the RAN may decrease the backoff parameter value to allow more frequent preamble transmissions.

The UE may determine a backoff time for delaying a subsequent random access transmission (e.g., MSG1) based on the backoff parameter value. For example, in cases where the UE may not receive or be unable to decode MSG2 or MSG4 in a random access procedure, the UE may retry sending a subsequent random access preamble. In certain cases, the backoff parameter value may be used in a probability formula for selecting a random backoff time for determining a delay for the subsequent random access transmission. As an example, the UE may select a random backoff time according to a uniform distribution between 0 and the backoff parameter value indicated in the RAR, and the UE may delay sending a random access preamble by the selected backoff time.

In certain aspects, the backoff subheader may be multi-compatible for codeword-based RACH communications and non-codeword-based RACH communications.

FIG. 8C is a diagram illustrating an example backoff subheader 808. In this example, the backoff subheader 880 includes the extension field 820, the type field 822, one or more backoff extension indicator fields 840, and a backoff indicator (BI) field 842, for example, arranged in an octet (October 1). In certain aspects, the extension field 820 may not be used, interpreted, or decoded for a backoff subheader. The UE may ignore or refrain from decoding the extension field 820 for the backoff subheader 808.

As described herein with respect to FIG. 8A, the type field 822 may be or include a flag indicating whether the subheader includes a RAPID or a Backoff Indicator. The type field 822 may be set to a different value from the value set for the RAPID subheader 806 in order to indicate that the given subheader includes a backoff parameter value.

The one or more backoff extension fields 840 may be used to expand the bit space for indicating the backoff parameter value for codeword-based RACH communications. For example, a combination of the BI field 842 and the one or more backoff extension fields 840 may indicate the backoff parameter value for codeword-based RACH communications. In some cases, the backoff parameter value may be determined based on the values associated with the BI field 842 and the one or more backoff extension fields 840. As an example, the one or more backoff extension fields 840 may indicate an adjustment factor or scaling factor by which the value for the BI field 842 is to be determined (e.g., multiplied, divided, added, or subtracted). The one or more backoff extension fields 840 may include one or more bits (e.g., 1-2 bits) in the octet.

In certain aspects, the one or more backoff extension fields 840 may correspond to one or more reserved bits for non-codeword-based RACH communications. For example, a UE that does not support codeword-based RACH communications may ignore or refrain from interpreting the one or more backoff extension fields 840. Thus, such an architecture for the RAR as described herein allows compatibility with (or support for handling congestion for) multiple types of random access preambles (e.g., codeword-based preambles and non-codeword-based preambles). In some cases, different types of UEs may be given different backoffs, such as to help with congestion. As an example, the UEs that support codeword-based communications may be given a shorter backoff parameter value relative to the other types of UEs, for example, to free random access resources for the codeword-based RACH communications or due to the smaller number of codeword-based RACH transmissions.

The BI field 842 may indicate the overload condition in the cell. The size of the BI field 842 may be or include 4 bits, for example.

In certain aspects, RAN may send separate RAR(s) for codeword-based RACH communications, for example, as a separate RAR transmission (e.g., a separate TB for OCC-supporting UEs) or via data segmentation (e.g., in the second data portion 714b) as described herein with respect to FIG. 7. In some cases, a codeword-specific RAR may include a codeword-specific BI. For example, a backoff subheader for codeword-based RACH communications may be included in the data block carrying the RAR(s).

For certain aspects, the RAN may send scheduling (e.g., DCI) for a codeword-specific RAR transmission using a codeword-specific RA-RNTI. For example, the DCI (or a cyclic redundancy check (CRC) thereof) may be scrambled using the codeword-specific RA-RNTI, and the UE may decode (or descramble) the DCI using the RA-RNTI. The codeword-specific RA-RNTI may allow the RAN to multicast or groupcast the codeword-specific RAR to UEs supporting codeword-based communications. The UE may be configured with a codeword-specific RA-RNTI, and the UE may use the RA-RNTI to descramble a DCI message scheduling the RAR. The codeword-specific RA-RNTI may be determined using an offset assigned to codeword-supporting UEs to distinguish the codeword-specific RA-RNTI from a different RA-RNTI. As an example, for NB-IoT UEs, the RA-RNTI associated with the PRACH in which the Random Access Preamble may be transmitted, may be computed as:

RA-RNTI=1+floor(SFN_id/4)+256*carrier_id+c_adj

where SFN_id is the index of the first radio frame of the specified PRACH, carrier_id is the index of the UL carrier associated with the specified PRACH, and c_adj may be an offset for codeword-based RACH communications. The carrier_id of the anchor carrier may be 0. Some UEs may be configured to monitor a certain number of RA-RNTIs (e.g., only one or two). For a specific codeword (e.g., a codeword having all ones in binary), the UE may monitor the non-codeword-based RA-RNTI, depending on the NPRACH preamble configuration (and/or RACH partitioning) supported.

In certain aspects, the UE may treat a certain codeword (e.g., a codeword having all ones in a binary format) for a RACH communication (e.g., a preamble transmission, a RAR, and/or MSG3) as though such a RACH communication is not codeword-based. For example, a preamble transmission that uses the codeword having all ones (in binary) may be equivalent to a non-codeword-based preamble transmission, and thus, the various codeword-based aspects described herein may not apply to that particular codeword (e.g., the codeword having all ones).

Codeword-specific information (such as a RAR, RA-RNTI, backoff parameter value, BI, or the like) related to random access communications may refer to certain information that is dedicated to or specifically produced for codeword-based random access communications. For example, UE(s) that support codeword-based random access communications may be configured to use the codeword-specific information, whereas other UE(s) that do not support codeword-based random access communications may ignore or refrain from using the codeword-specific information.

### Example Operations of Entities in a Communications Network

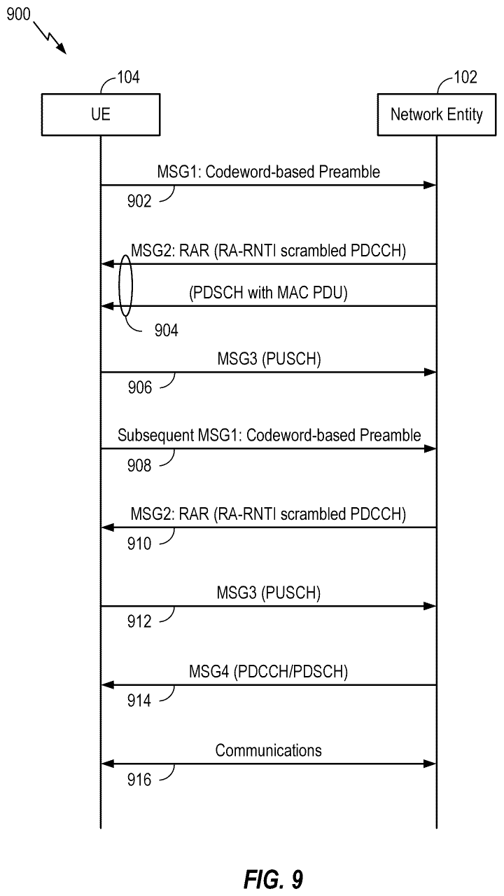

FIG. 9 depicts a process flow 900 for communications in a network between the BS 102 (referred to in this example as a network entity) and the UE 104. In some aspects, the network entity 102 may be an example of the base station depicted and described with respect to FIGS. 1 and 3 or a disaggregated base station depicted and described with respect to FIG. 2. However, in other aspects, the UE 104 may be another type of wireless communications device, and network entity 102 may be another type of network entity or network node, such as those described herein.

At 902, the UE 104 may transmit, to the network entity 102, a random access preamble (MSG1) in a RACH, such as the NPRACH, as described herein with respect to FIG. 6. The preamble may be multiplexed using a codeword, such as a codeword associated with an orthogonal cover code (OCC). In certain aspects, the UE 104 may randomly select the codeword among a set of codewords as configured by the RAN and/or specified in certain wireless communication standards, such as the 3GPP standards for NB-IoT communications.

At 904, the UE 104 may receive, from the network entity 102, a random access response (RAR) associated with the preamble transmission. The RAR may also be referred to as MSG2. For example, the UE 104 may receive, from the network entity 102, a PDCCH transmission scrambled with an RA-RNTI. The PDCCH may carry DCI scheduling the RAR. The UE 104 may receive, from the network entity, a PDSCH transmission carrying the RAR (e.g., a MAC PDU with the RAR payload associated with the preamble) in accordance with the scheduling indicating in the DCI. The RAR may provide an UL grant for MSG3. In some cases, the RAR may be compatible for multiple types of random access communications, for example, as described herein with respect to FIGS. 7 and 8A-8C. In certain cases, the RAR may be specific to codeword-based random access communications. For example, the RA-RNTI used to the scramble the PDCCH transmission may be allocated for codeword-based random access communications, as described herein. In certain aspects, the RAR may indicate a backoff parameter value that is specific to codeword-based random access communications.

At 906, in response to MSG2, the UE 104 may transmit, to the network entity 102, MSG3 via the PUSCH in accordance with the UL grant indicated in the RAR.

At 908, the UE 104 may transmit, to the network entity 102, a subsequent random access preamble in a RACH occasion. As an example, in some cases, the UE 104 may not receive or be unable to decode MSG2 and/or MSG4, and in such cases, the UE 104 may reinitiate the random access procedure via a subsequent preamble transmission. The UE 104 may identify the RACH occasion for the subsequent random access preamble based on a backoff parameter value, for example, as indicated in the RAR at 904. In certain cases, the backoff parameter value may be indicated in the RAR as described herein with respect to FIG. 8C. In some cases, a codeword-specific RAR (e.g., a RAR transmitted via a codeword-specific RA-RNTI) may indicate or include a backoff parameter value associated with codeword-based random access communications.

At 910, the UE 104 may receive, from the network entity 102, a RAR associated with the subsequent preamble transmission. The RAR may schedule a MSG3 transmission via an UL grant.

At 912, the UE 104 may transmit, to the network entity 102, MSG3 via the PUSCH in accordance with the UL grant indicated in the RAR. In some aspects, MSG3 may include an RRC connection request, a tracking area update, and/or a scheduling request (for an UL transmission).

At 914, the UE 104 may receive, from the network entity 102, a contention resolution message (MSG4) in response to MSG3. In some cases, the MSG4 may include an RRC connection setup message in response to the RRC connection request and/or an UL grant in response to the scheduling request, for example.

At 916, the UE 104 may communicate with the network entity 102 based on the RACH communications. As an example, the UE 104 may apply any configuration for the communication link between the UE 104 and the network entity 102 as indicated or included in the RRC connection setup message. The RRC connection setup message may indicate or include various configurations, such as configuration(s) for control signaling (e.g., a PDCCH or a control resource set), PUSCH, PUCCH, PDSCH, transmit power control(s), channel state feedback reporting (e.g., CSI reporting), SRS, antenna configuration, and/or scheduling requests. In certain aspects, the configuration provided in the RRC connection setup message may facilitate the reception of subsequent configurations. In some cases, the UE 104 may transmit an UL signal in accordance with the UL grant provided in MSG4.

Those of skill in the art will understand that the process flow 900 is an example of a codeword-based CBRA procedure. Other signaling may be used in addition to or instead of those illustrated in the process flow 900, such as signaling associated with a CFRA procedure and/or a two-step RACH procedure, for example, as described herein with respect to FIG. 5B.

### Example Operations of a User Equipment

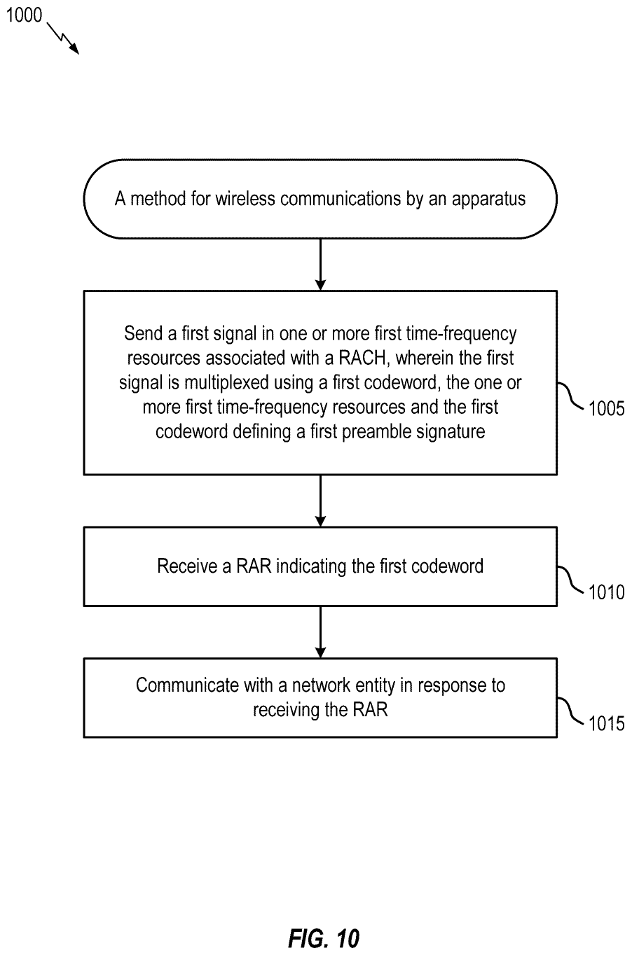

FIG. 10 shows a method 1000 for wireless communications by an apparatus, such as UE 104 of FIGS. 1 and 3.

Method 1000 begins at block 1005 with sending a first signal in one or more first time-frequency resources associated with a RACH (for example, as described herein with respect to FIG. 6), wherein the first signal is multiplexed using a first codeword, the one or more first time-frequency resources and the first codeword defining a first preamble signature.

Method 1000 then proceeds to block 1010 with receiving a RAR indicating the first codeword. For example, the RAR may identify the association between the RAR and the first signal via at least an indication of the first codeword, as described herein, with respect to FIGS. 7, 8A, and 8B.

Method 1000 then proceeds to block 1015 with communicating with a network entity (e.g., the network entity 102) in response to receiving the RAR. For example, the UE may communicate with the network entity as described herein with respect to FIG. 9.

In certain aspects, block 1010 includes receiving a data block comprising a first data portion (e.g., the first data portion 714a) and a second data portion (e.g., the second data portion 714b), the first data portion comprising one or more first RARs associated with non-codeword-based RACH communications, the second data portion comprising one or more second RARs (e.g., the codeword-specific RAR(s) 712) associated with codeword-based RACH communications, and the one or more second RARs comprising the RAR. The data block may include a packet, a transport block, and/or a MAC PDU, for example, as described herein with respect to FIG. 7. In certain aspects, the second data portion corresponds to one or more padding bits of the data block. As an example the one or more first RARs associated with non-codeword-based RACH communications may include a RAR that identifies a non-codeword-based preamble transmission, whereas the one or more second RARs associated with codeword based RACH communications may include a RAR that identifies a codeword-based preamble, for example, as described herein with respect to FIG. 7. In certain aspects, the second data portion is reserved for indicating information (e.g., the information in a RAR payload as described herein with respect to FIG. 8B) associated with the codeword-based RACH communications.

In certain aspects, block 1010 includes receiving a data block comprising a RAR header and a RAR payload that is associated with the RAR header, the first codeword being indicated via at least one of (i) a field in the RAR header or (ii) one or more bits in the RAR payload. In certain aspects, the field in the RAR header is associated with a RAPID. In certain aspects, the one or more values for the field are specific to codeword-based RACH communications. In certain aspects, the one or more bits in the RAR payload are specific to codeword-based RACH communications. In some cases, the UE(s) that do not support codeword-based RACH communications may ignore or refrain from decoding the one or more bits in the RAR payload. The RAR payload that is associated with the RAR header may be or include the RAR payload that corresponds to the order in which the RAR header (e.g., the corresponding RAPID subheader 706) is arranged in a MAC header, for example, as described herein with respect to FIG. 7. The field that is associated with a RAPID may be or include, for example, the RAPID field, as described herein with respect to FIG. 8B.

In certain aspects, method 1000 further includes receiving DCI scrambled with a RA-RNTI that is associated with codeword-based RACH communications, wherein the DCI indicates scheduling for the RAR. In certain aspects, the RA-RNTI is specific to codeword-based RACH communications. In certain aspects, block 1010 includes receiving the RAR and an indication of a backoff value (e.g., a backoff parameter value as indicated via a backoff indicator (BI) field) in accordance with the scheduling, the backoff value indicating (or being associated with) a RACH occasion for sending a subsequent RACH preamble transmission. In certain aspects, the backoff value is specific to codeword-based RACH communications. In certain aspects, method 1000 further includes sending a second signal in one or more second time-frequency resources associated with the RACH, wherein the second signal is multiplexed using a second codeword, and the one or more second time-frequency resources and the second codeword define a second preamble signature. For example, the second signal may be or include a subsequent preamble transmission as described herein with respect to FIG. 9. As an example, the RA-RNTI that is associated with codeword-based RACH communications may include a codeword-specific RA-RNTI, for example, assigned to NB-IoT UEs that support codeword-based random access communications.

In certain aspects, block 1010 includes receiving a data block comprising a BI header and the RAR, the BI header comprising a BI field and one or more bits, wherein the BI field and the one or more bits indicate (or are associated with) a RACH occasion for sending a subsequent RACH preamble transmission, for example, as described herein with respect to FIG. 8C. In certain aspects, the BI field and the one or more bits indicate a backoff value that is specific to codeword-based RACH communications. In certain aspects, method 1000 further includes sending a second signal in the RACH occasion.

In certain aspects, block 1010 includes receiving the RAR via a MAC PDU, such as the MAC PDU 700.

In certain aspects, the RACH comprises a NPRACH, for example, as described herein with respect to FIG. 6. In certain aspects, the apparatus comprises an IoT device, such as an NB-IoT device.

In certain aspects, the first codeword is associated with code division multiplexing, for example, an orthogonal cover code. In certain aspects, the first codeword is associated with an orthogonal cover code, for example, a codeword used in an orthogonal cover code.

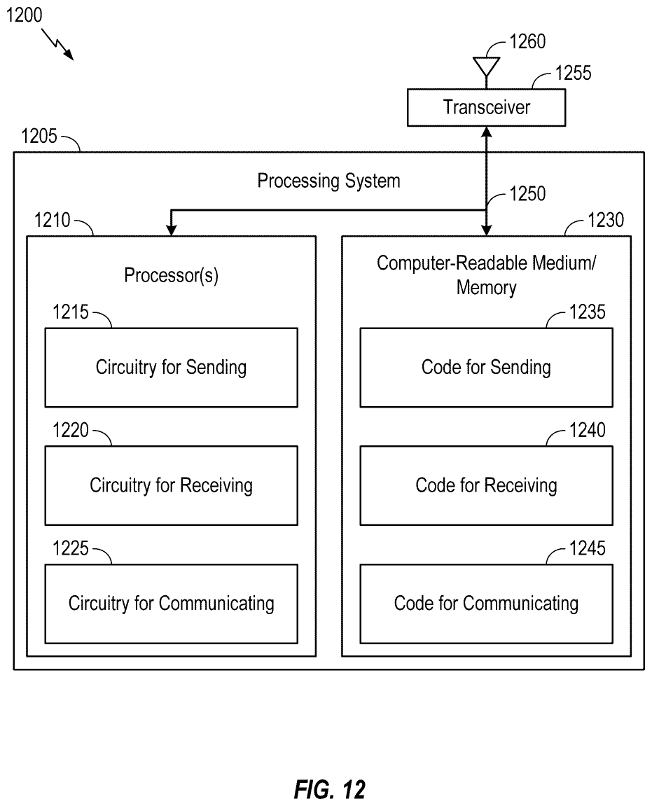

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Network Entity

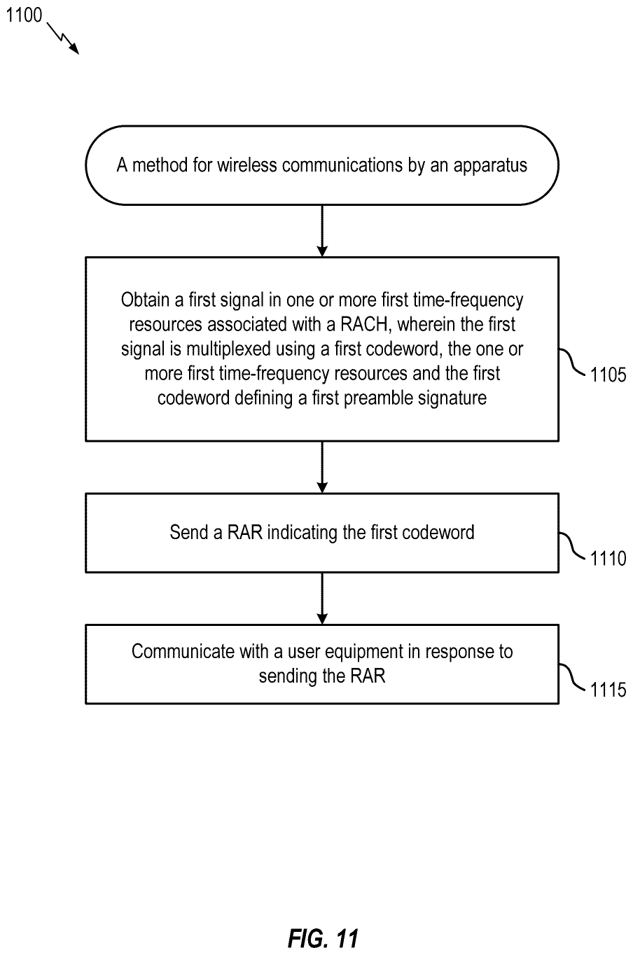

FIG. 11 shows a method 1100 for wireless communications by an apparatus, such as BS 102 of FIGS. 1 and 3, or a disaggregated base station as discussed with respect to FIG. 2.

Method 1100 begins at block 1105 with obtaining a first signal in one or more first time-frequency resources associated with a RACH, wherein the first signal is multiplexed using a first codeword, the one or more first time-frequency resources and the first codeword defining a first preamble signature.

Method 1100 then proceeds to block 1110 with sending a RAR indicating the first codeword.

Method 1100 then proceeds to block 1115 with communicating with a user equipment in response to sending the RAR.

In certain aspects, block 1110 includes sending a data block comprising a first data portion and a second data portion, the first data portion comprising one or more first RARs associated with non-codeword-based RACH communications, the second data portion comprising one or more second RARs associated with codeword-based RACH communications, and the one or more second RARs comprising the RAR. In certain aspects, the second data portion corresponds to one or more padding bits of the data block. In certain aspects, the second data portion is reserved for indicating information associated with the codeword-based RACH communications.

In certain aspects, block 1110 includes sending a data block comprising a RAR header and a RAR payload that is associated with the RAR header, the first codeword being indicated via at least one of (i) a field in the RAR header or (ii) one or more bits in the RAR payload. In certain aspects, the field in the RAR header is associated with a RAPID. In certain aspects, one or more values for the field are specific to codeword-based RACH communications. In certain aspects, the one or more bits in the RAR payload are specific to codeword-based RACH communications. In some cases, the UE(s) that do not support codeword-based RACH communications may ignore or refrain from decoding the one or more bits in the RAR payload.

In certain aspects, method 1100 further includes sending DCI scrambled with a RA-RNTI that is associated with codeword-based RACH communications, wherein the DCI indicates scheduling for the RAR. In certain aspects, the RA-RNTI is specific to codeword-based RACH communications. In certain aspects, block 1110 includes sending the RAR and an indication of a backoff value in accordance with the scheduling, the backoff value indicating (or being associated with) a RACH occasion for a user equipment to send a subsequent RACH preamble transmission. In certain aspects, the backoff value is specific to codeword-based RACH communications. In certain aspects, method 1100 further includes obtaining a second signal in one or more second time-frequency resources associated with the RACH, wherein the second signal is multiplexed using a second codeword, and the one or more second time-frequency resources and the second codeword define a second preamble signature.

In certain aspects, block 1110 includes sending a data block comprising a BI header and the RAR, the BI header comprising a BI field and one or more bits, wherein the BI field and the one or more bits indicate (and are associated with) a RACH occasion for a user equipment to send a subsequent RACH preamble transmission. In certain aspects, the BI field and the one or more bits indicate a backoff value that is specific to codeword-based RACH communications. In certain aspects, method 1100 further includes obtaining a second signal in the RACH occasion.

In certain aspects, block 1110 includes sending the RAR via a MAC PDU.

In certain aspects, the RACH comprises a NPRACH.

In certain aspects, the first codeword is associated with code division multiplexing. In certain aspects, the first codeword is associated with an orthogonal cover code.

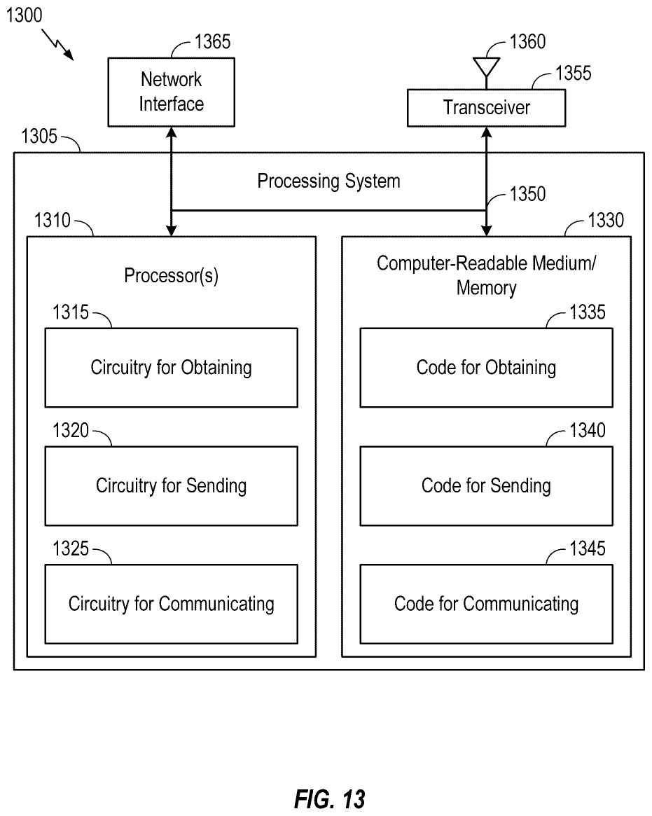

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code and/or processor-executable instructions) that when executed by the one or more processors 1210, enable and cause the one or more processors 1210 to perform the method 1000 described with respect to FIG. 10, or any aspect related to it, including any additional operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code for sending 1235, code for receiving 1240, and code for communicating 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for sending 1215, circuitry for receiving 1220, and circuitry for communicating 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the transceivers 354, antenna(s) 352, receive processor 358, and/or controller/processor 380 of the UE 104 illustrated in FIG. 3, transceiver 1255 and/or antenna 1260 of the communications device 1200 in FIG. 12, and/or one or more processors 1210 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1355 (e.g., a transmitter and/or a receiver) and/or a network interface 1365. The transceiver 1355 is configured to transmit and receive signals for the communications device 1300 via an antenna 1360, such as the various signals as described herein. The network interface 1365 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, enable and cause the one or more processors 1310 to perform the method 1100 described with respect to FIG. 11, or any aspect related to it, including any additional operations described in relation to FIG. 11. Note that reference to a processor of communications device 1300 performing a function may include one or more processors of communications device 1300 performing that function, such as in a distributed fashion.

In the depicted example, the computer-readable medium/memory 1330 stores code for obtaining 1335, code for sending 1340, and code for communicating 1345. Processing of the code 1335-1345 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry for obtaining 1315, circuitry for sending 1320, and circuitry for communicating 1325. Processing with circuitry 1315-1325 may enable and cause the communications device 1300 to perform the method 1100 described with respect to FIG. 11, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1355 and/or antenna 1360 of the communications device 1300 in FIG. 13, and/or one or more processors 1310 of the communications device 1300 in FIG. 13. Means for communicating, receiving or obtaining may include the transceivers 332, antenna(s) 334, receive processor 338, and/or controller/processor 340 of the BS 102 illustrated in FIG. 3, transceiver 1355 and/or antenna 1360 of the communications device 1300 in FIG. 13, and/or one or more processors 1310 of the communications device 1300 in FIG. 13.

### Example Clauses

Implementation examples are described in the following numbered clauses:
Clause 1: A method for wireless communications by an apparatus comprising: sending a first signal in one or more first time-frequency resources associated with a RACH, wherein the first signal is multiplexed using a first codeword, the one or more first time-frequency resources and the first codeword defining a first preamble signature; receiving a RAR indicating the first codeword; and communicating with a network entity in response to receiving the RAR.
Clause 2: The method of Clause 1, wherein receiving the RAR comprises: receiving a data block comprising a first data portion and a second data portion, the first data portion comprising one or more first RARs associated with non-codeword-based RACH communications, the second data portion comprising one or more second RARs associated with codeword-based RACH communications, and the one or more second RARs comprising the RAR.
Clause 3: The method of Clause 2, wherein the second data portion corresponds to one or more padding bits of the data block.
Clause 4: The method of any one of Clauses 1-3, wherein receiving the RAR comprises: receiving a data block comprising a RAR header and a RAR payload that is associated with the RAR header, the first codeword being indicated via at least one of (i) a field in the RAR header or (ii) one or more bits in the RAR payload.
Clause 5: The method of Clause 4, wherein the field in the RAR header is associated with a RAPID.
Clause 6: The method of Clause 5, wherein one or more values for the field are specific to codeword-based RACH communications.
Clause 7: The method of any one of Clauses 4-6, wherein the one or more bits in the RAR payload are specific to codeword-based RACH communications.
Clause 8: The method of any one of Clauses 1-7, further comprising: receiving DCI scrambled with a RA-RNTI that is specific to codeword-based RACH communications, wherein the DCI indicates scheduling for the RAR.
Clause 9: The method of Clause 8, wherein receiving the RAR comprises receiving the RAR and an indication of a backoff value in accordance with the scheduling, the backoff value being associated with a RACH occasion for sending a subsequent RACH preamble transmission.
Clause 10: The method of Clause 9, wherein the backoff value is specific to codeword-based RACH communications.
Clause 11: The method of any one of Clauses 1-10, wherein receiving the RAR comprises receiving a data block comprising a BI header and the RAR, the BI header comprising a BI field and one or more bits, wherein the BI field and the one or more bits are associated with a RACH occasion for sending a subsequent RACH preamble transmission.
Clause 12: The method of Clause 11, further comprising sending a second signal in the RACH occasion.
Clause 13: The method of any one of Clauses 1-12, wherein receiving the RAR comprises receiving the RAR via a MAC PDU.
Clause 14: The method of any one of Clauses 1-13, wherein the RACH comprises a NPRACH.
Clause 15: The method of any one of Clauses 1-14, wherein the apparatus comprises an IoT device.
Clause 16: The method of any one of Clauses 1-15, wherein the first codeword is associated with code division multiplexing.
Clause 17: The method of any one of Clauses 1-16, wherein the first codeword is associated with an orthogonal cover code.
Clause 18: A method for wireless communications by an apparatus comprising: obtaining a first signal in one or more first time-frequency resources associated with a RACH, wherein the first signal is multiplexed using a first codeword, the one or more first time-frequency resources and the first codeword defining a first preamble signature; sending a RAR indicating the first codeword; and communicating with a user equipment in response to sending the RAR.
Clause 19: The method of Clause 18, wherein sending the RAR comprises: sending a data block comprising a first data portion and a second data portion, the first data portion comprising one or more first RARs associated with non-codeword-based RACH communications, the second data portion comprising one or more second RARs associated with codeword-based RACH communications, and the one or more second RARs comprising the RAR.
Clause 20: The method of Clause 19, wherein the second data portion corresponds to one or more padding bits of the data block.
Clause 21: The method of any one of Clauses 18-20, wherein sending the RAR comprises: sending a data block comprising a RAR header and a RAR payload that is associated with the RAR header, the first codeword being indicated via at least one of (i) a field in the RAR header or (ii) one or more bits in the RAR payload.
Clause 22: The method of Clause 21, wherein the field in the RAR header is associated with a RAPID.
Clause 23: The method of Clause 22, wherein one or more values for the field are specific to codeword-based RACH communications.
Clause 24: The method of any one of Clause 21-23, wherein the one or more bits in the RAR payload are specific to codeword-based RACH communications.
Clause 25: The method of any one of Clauses 18-24, further comprising:
sending DCI scrambled with a RA-RNTI that is specific to codeword-based RACH communications, wherein the DCI indicates scheduling for the RAR.
Clause 26: The method of Clause 25, wherein sending the RAR comprises sending the RAR and an indication of a backoff value in accordance with the scheduling, the backoff value being associated with a RACH occasion for a user equipment to send a subsequent RACH preamble transmission.
Clause 27: The method of Clause 26, wherein the backoff value is specific to codeword-based RACH communications.
Clause 28: The method of any one of Clauses 18-27, wherein sending the RAR comprises sending a data block comprising a BI header and the RAR, the BI header comprising a BI field and one or more bits, wherein the BI field and the one or more bits are associated with a RACH occasion for a user equipment to send a subsequent RACH preamble transmission.
Clause 29: The method of Clause 28, wherein BI field and the one or more bits indicate a backoff value that is specific to codeword-based RACH communications.
Clause 30: The method of any one of Clauses 18-29, wherein sending the RAR comprises sending the RAR via a MAC PDU.
Clause 31: The method of any one of Clauses 18-30, wherein the RACH comprises a NPRACH.
Clause 32: The method of any one of Clauses 18-31, wherein the first codeword is associated with code division multiplexing.
Clause 33: The method of any one of Clauses 18-32, wherein the first codeword is associated with an orthogonal cover code.
Clause 34: One or more apparatuses, comprising: one or more memories; and one or more processors coupled to the one or more memories, the one or more processors being configured to cause the one or more apparatuses to perform a method in accordance with any one of Clauses 1-33.
Clause 35: One or more apparatuses, comprising means for performing a method in accordance with any one of Clauses 1-33.
Clause 36: One or more non-transitory computer-readable media comprising executable instructions that, when executed by one or more processors of one or more apparatuses, cause the one or more apparatuses to perform a method in accordance with any one of Clauses 1-33.
Clause 37: One or more computer program products embodied on one or more computer-readable storage media comprising code for performing a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or processors being configured to cause the apparatus to:
send a first signal in one or more first time-frequency resources associated with a random access channel (RACH), wherein the first signal is multiplexed using a first codeword, the one or more first time-frequency resources and the first codeword defining a first preamble signature;
receive a random access response (RAR) indicating the first codeword; and
communicate with a network entity in response to receiving the RAR.

2. The apparatus of claim 1, wherein to receive the RAR, the one or more processors are configured to cause the apparatus to: receive a data block comprising a first data portion and a second data portion, the first data portion comprising one or more first RARs associated with non-codeword-based RACH communications, the second data portion comprising one or more second RARs associated with codeword-based RACH communications, and the one or more second RARs comprising the RAR.

3. The apparatus of claim 1, wherein to receive the RAR, the one or more processors are configured to cause the apparatus to: receive a data block comprising a RAR header and a RAR payload that is associated with the RAR header, the first codeword being indicated via at least one of (i) a field in the RAR header or (ii) one or more bits in the RAR payload.

4. The apparatus of claim 3, wherein the field in the RAR header is associated with a random access preamble identifier (RAPID), and one or more values for the field are specific to codeword-based RACH communications.

5. The apparatus of claim 3, wherein the one or more bits in the RAR payload are specific to codeword-based RACH communications.

6. The apparatus of claim 1, wherein the one or more processors are configured to cause the apparatus to: receive downlink control information (DCI) scrambled with a random access radio network temporary identifier (RA-RNTI) that is specific to codeword-based RACH communications, wherein the DCI indicates scheduling for the RAR.

7. The apparatus of claim 6, wherein to receive the RAR, the one or more processors are configured to cause the apparatus to receive the RAR and an indication of a backoff value in accordance with the scheduling, the backoff value being associated with a RACH occasion for sending a subsequent RACH preamble transmission, wherein the backoff value is specific to codeword-based RACH communications.

8. The apparatus of claim 1, wherein to receive the RAR, the one or more processors are configured to cause the apparatus to receive a data block comprising a backoff indicator (BI) header and the RAR, the BI header comprising a BI field and one or more bits, wherein the BI field and the one or more bits are associated with a RACH occasion for sending a subsequent RACH preamble transmission, wherein the BI field and the one or more bits indicate a backoff value that is specific to codeword-based RACH communications.

9. The apparatus of claim 1, wherein the first codeword is associated with code division multiplexing.

10. The apparatus of claim 1, wherein the first codeword is associated with an orthogonal cover code.

11. An apparatus configured for wireless communications, comprising:
one or more memories; and
one or more processors coupled to the one or memories, the one or more processors being configured to cause the apparatus to:
obtain a first signal in one or more first time-frequency resources associated with a random access channel (RACH), wherein the first signal is multiplexed using a first codeword, the one or more first time-frequency resources and the first codeword defining a first preamble signature;
send a random access response (RAR) indicating the first codeword; and
communicate with a user equipment in response to sending the RAR.

12. The apparatus of claim 11, wherein to send the RAR, the one or more processors are configured to cause the apparatus to: send a data block comprising a first data portion and a second data portion, the first data portion comprising one or more first RARs associated with non-codeword-based RACH communications, the second data portion comprising one or more second RARs associated with codeword-based RACH communications, and the one or more second RARs comprising the RAR.

13. The apparatus of claim 11, wherein to send the RAR, the one or more processors are configured to cause the apparatus to: send a data block comprising a RAR header and a RAR payload that is associated with the RAR header, the first codeword being indicated via at least one of (i) a field in the RAR header or (ii) one or more bits in the RAR payload.

14. The apparatus of claim 13, wherein the field in the RAR header is associated with a random access preamble identifier (RAPID), and one or more values for the field are specific to codeword-based RACH communications.

15. The apparatus of claim 13, wherein the one or more bits in the RAR payload are specific to codeword-based RACH communications.

16. The apparatus of claim 11, wherein the one or more processors are configured to cause the apparatus to: send downlink control information (DCI) scrambled with a random access radio network temporary identifier (RA-RNTI) that is specific to codeword-based RACH communications, wherein the DCI indicates scheduling for the RAR.

17. The apparatus of claim 16, wherein to send the RAR, the one or more processors are configured to cause the apparatus to send the RAR and an indication of a backoff value in accordance with the scheduling, the backoff value being associated with a RACH occasion for a user equipment to send a subsequent RACH preamble transmission, and the backoff value is specific to codeword-based RACH communications.

18. The apparatus of claim 11, wherein to send the RAR, the one or more processors are configured to cause the apparatus to send a data block comprising a backoff indicator (BI) header and the RAR, the BI header comprising a BI field and one or more bits, wherein the BI field and the one or more bits are associated with a RACH occasion for a user equipment to send a subsequent RACH preamble transmission, and the BI field and the one or more bits indicate a backoff value that is specific to codeword-based RACH communications.

19. The apparatus of claim 11, wherein the first codeword is associated with code division multiplexing.

20. A method of wireless communications by an apparatus, comprising:
sending a first signal in one or more first time-frequency resources associated with a random access channel (RACH), wherein the first signal is multiplexed using a first codeword, the one or more first time-frequency resources and the first codeword defining a first preamble signature;
receiving a random access response (RAR) indicating the first codeword; and
communicating with a network entity in response to receiving the RAR.
